(19) United States
(12) Patent Application Publication
(10) Pub. No.: US 2014/0036022 A1
(43) Pub. Date: Feb. 6, 2014

(54) PROVIDING A CONVERSATIONAL VIDEO EXPERIENCE

(71) Applicant: Volio, Inc., San Francisco, CA (US)

(72) Inventors: Ronald A. Croen, San Francisco, CA (US); Mark T. Anikst, Santa Monica, CA (US); Vidur Apparao, San Mateo, CA (US); Bernt Habermeier, San Francisco, CA (US); Todd A. Mendeloff, Los Angeles, CA (US)

(21) Appl. No.: 13/907,515

(22) Filed: May 31, 2013

Related U.S. Application Data
(60) Provisional application No. 61/653,923, filed on May 31, 2012.

(51) Int. Cl. H04N 7/14

(52) U.S. Cl. CPC H04N 7/147
USPC 348/14.01

(57) ABSTRACT

Providing a conversational video experience is disclosed. In various embodiments, a user response data provided by a user in response to a first video segment at least a portion of which has been rendered to the user is received. The user response data is processed to generate a text-based representation of a user response indicated by the user response data. A response concept with which the user response is associated is determined based at least in part on the text-based representation. A next video segment to be rendered to the user is selected based at least in part on the response concept.

### CROSS REFERENCE TO OTHER APPLICATIONS

This application claims priority to U.S. Provisional Patent Application No. 61/653,923 (Attorney Docket No. NUMEP002+) entitled PROVIDING A CONVERSATIONAL VIDEO EXPERIENCE, filed May 31, 2012, which is incorporated herein by reference for all purposes.

### BACKGROUND OF THE INVENTION

Speech recognition technology is used to convert human speech (audio input) to text or data representing text (text-based output). Applications of speech recognition technology to date have included voice-operated user interfaces, such as voice dialing of mobile or other phones, voice-based search, interactive voice response (IVR) interfaces, and other interfaces. Typically, a user must select from a constrained menu of valid responses, e.g., to navigate a hierarchical sets of menu options.

Attempts have been made to provide interactive video experiences, but typically such attempts have lacked key elements of the experience human users expect when they participate in a conversation.

### BRIEF DESCRIPTION OF THE DRAWINGS

Various embodiments of the invention are disclosed in the following detailed description and the accompanying drawings.

FIG. 1 is a block diagram illustrating an embodiment of a system to provide a conversational video experience.

FIG. 2 is a block diagram illustrating an embodiment of a system to provide a conversational video experience.

FIG. 3 is a block diagram illustrating an embodiment of a conversational video runtime engine.

FIG. 4A is a block diagram illustrating an embodiment of a conversational video experience display and interface.

FIG. 4B is a block diagram illustrating an embodiment of a conversational video experience display and interface.

FIG. 4C is a block diagram illustrating an embodiment of a conversational video experience display and interface.

FIG. 5 is a block diagram illustrating an embodiment of a conversational video experience.

FIG. 6 is a block diagram illustrating an embodiment of a conversational video experience.

FIG. 7 is a block diagram illustrating an embodiment of a conversational video experience segment.

FIG. 8A is a flow chart illustrating an embodiment of a process to provide a conversational video experience.

FIG. 8B is a flow chart illustrating an embodiment of a process to provide a conversational video experience.

FIG. 9 is a flow chart illustrating an embodiment of a process to receive and interpret user responses.

FIG. 10 is a block diagram illustrating an embodiment of elements of a conversational video experience system.

FIG. 11 is a block diagram illustrating an embodiment of a conversational video experience next segment decision engine.

FIG. 12 is a flow chart illustrating an embodiment of a process to provide and update a response understanding model.

FIG. 13 is a flow chart illustrating an embodiment of a process to integrate a transition video into a conversation video experience.

FIG. 14 is a flow chart illustrating an embodiment of a process to provide a dynamic active listening experience.

FIG. 15 is a flow chart illustrating an embodiment of a process to record a user's side of a conversational video experience.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A conversational video runtime system is disclosed. In various embodiments, the system emulates a virtual participant in a conversation with a real participant (a user). It presents the virtual participant as a video persona, created in various embodiments based on recording or capturing aspects of a real person or other persona participating in the persona's end of the conversation. The video persona in various embodiments may be one or more of an actor or other human subject; a puppet, animal, or other animate or inanimate object; and/or pre-rendered video, for example of a computer generated and/or other participant. In various embodiments, the “conversation” may comprise one or more of spoken words, non-verbal gestures, and/or other verbal and/or non-verbal modes of communication capable of being recorded and/or otherwise captured via pre-rendered video and/or video recording. A script or set of scripts may be used to record discrete segments in which the subject affirms a user response to a previously-played segment, imparts information, prompts the user to provide input, and/or actively listens as one might do while listening live to another participant in the conversation. The system provides the video persona's side of the conversation by playing video segments on its own initiative and in response to what it heard and understood from the user side. It listens, recognizes and understands/interprets user responses, selects an appropriate response as a video segment, and delivers it in turn by playing the selected video segment. The goal of the system in various embodiments is to make the virtual participant in the form of a video persona as indistinguishable as possible from a real person participating in a conversation across a video channel. In various embodiments, the video “persona” may include one or more participants, e.g., a conversation with members of a rock band, and/or more than one real world user may interact with the conversational experience at the same time.

In a natural human conversation, participants acknowledge their understanding of the meaning or idea being conveyed by another and express their attitude to the understood content, with verbal and facial expressions or other cues. In general, the participants are allowed to interrupt each other and start responding to the other side if they choose to do so. These traits of a natural conversation are emulated in various embodiments by a conversing virtual participant to maintain a suspension of disbelief on the part of the user.

Architectural components and approaches taken in various embodiments to conduct such a conversation in a manner that is convincing and compelling are disclosed. In various embodiments, one or more of the following may be included:
Architecture: An exemplary architecture, including some of the primary components included in various embodiments, is disclosed.
Hierarchical language understanding: Statistical methods in various embodiments exploit the specific context of a particular application to determine from examples the intent of the user and the likely direction of a conversation.
Using context: Make responses more relevant and the conversation more efficient by using what is known about the user or previous conversations or interactions with the user.
Active Listening: Techniques for simulating the natural cadence of conversation, including visual and aural listening cues and interruptions by either party.
Video Transitions and Transformations: Methods for smoothing a virtual persona's transition between video segments and other video transformation techniques to simulate a natural conversation.
Multiple Recognizers: Improving performance and optimizing cost by using multiple speech recognizers.
Multiple response modes: Allowing the user to provide a response using speech, touch or other input modalities. The selection of the available input modes may be made dynamically by the system.
Social Sharing: Recording of all or part of the conversation for sharing via social networks or other channels.
Conversational Transitions: In some applications, data in the cloud or other aspects of the application context may require some time to retrieve or analyze. Techniques to make the conversation seem continuous through such transitions are disclosed.
Integrating audio-only content: Audio-only content (as opposed to audio that is part of video) can augment video content with more flexibility and less storage demands. A method of seamlessly incorporating it within a video interaction is described.

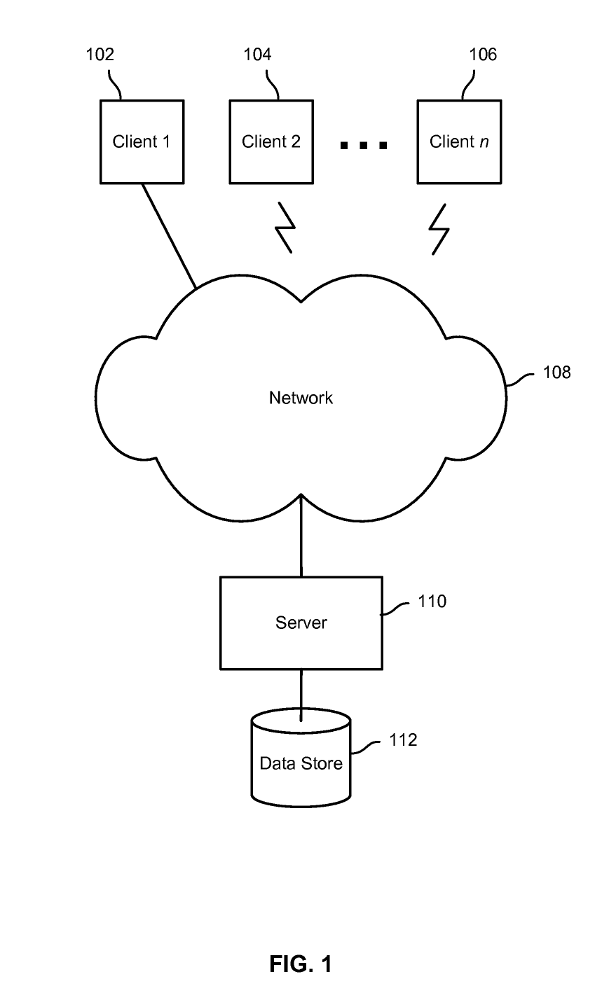

FIG. 1 is a block diagram illustrating an embodiment of a system to provide a conversational video experience. In the example shown, each of a plurality of clients, represented in FIG. 1 by clients 102, 104, 106, has access, e.g., via a wireless or wired connection to a network 108, to one or more conversational video experience servers, represented in FIG. 1 by server 110. Servers such as server 110 use conversational video experience assets stored in an associated data store, such as data store 112, to provide assets to respective ones of the clients, e.g., on request by a client side application or other code running on the respective clients, to enable a conversational video experience to be provided. Examples of client devices, such as clients 102, 104, and 106, included without limitation desktop, laptop, and/or other portable computers; iPad® and/or other tablet computers or devices; mobile phones and/or other mobile computing devices; and any other device capable of providing a video display and capturing user input provided by a user, e.g., a response spoken by the user. While a single server 110 is shown in FIG. 1, in various embodiments a plurality of servers may be used, e.g., to make the same conversational video experience available from a plurality of source, and/or to deploy different conversation video experiences from different servers. Examples of conversational video experience assets that may be stored in data stores such as data store 112 include, without limitation, video segments to be played in a prescribed order and/or manner to provide the video persona's side of a conversation and meta-information to be used to determine an order and/or timing in which such segments should be played.

A conversational video runtime system or runtime engine may be used in various embodiments to provide a conversational experience to a user in multiple different scenarios. For example:
Standalone application—A conversation with a single virtual persona or multiple conversations with different virtual personae could be packaged as a standalone application (delivered, for example, on a mobile device or through a desktop browser). In such a scenario, the user may have obtained the application primarily for the purpose of conducting conversations with virtual personae.
Embedded—One or more conversations with one or more virtual personae may be embedded within a separate application or web site with a broader purview. For example, an application or web site representing a clothing store could embed a conversational video with a spokesperson with the goal of helping a user make clothing selections.
Production tool—The runtime engine may be contained within a tool used for production of conversational videos. The runtime engine could be used for testing the current state of the conversational video in production.

In various implementations of the above, the runtime engine is incorporated and used by a container application. The container application may provide services and experiences to the user that complement or supplement those provided by the conversational video runtime engine, including discovery of new conversations; presentation of the conversation at the appropriate time in a broader user experience; presentation of related material alongside or in addition to the conversation; etc.

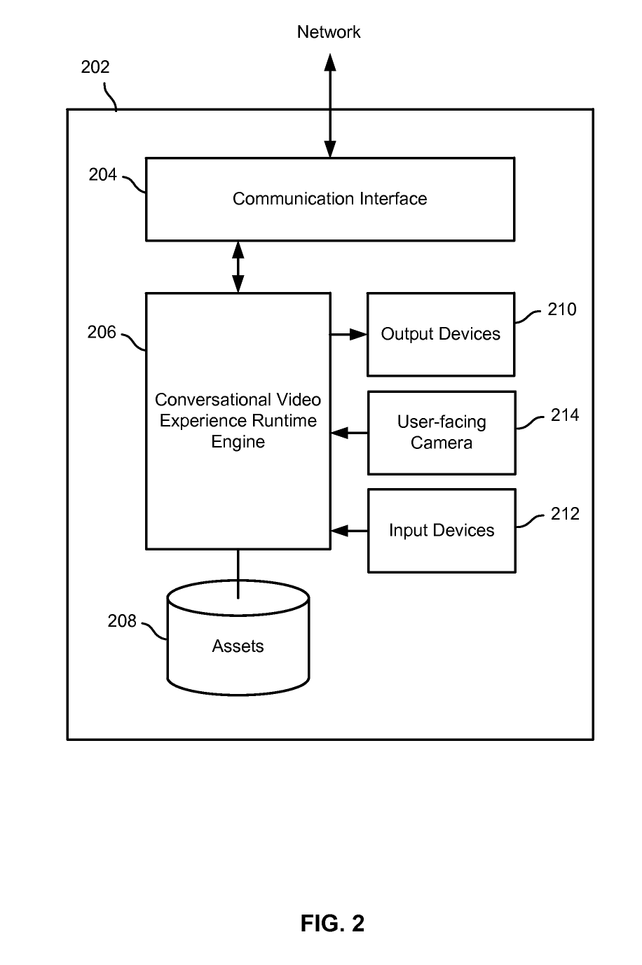

FIG. 2 is a block diagram illustrating an embodiment of a system to provide a conversational video experience. In the example shown, a device 202, such as tablet or other client device, includes a communication interface 204, which provides network connectivity. A conversational video experience runtime engine 206 communicates to the network via communication interface 204, for example to download video, meta-information, and/or other assets to be used to provide a conversational video experience. Downloaded assets (e.g., meta-information, video segments of video persona) and/or locally-generated assets (e.g., audio comprising responses spoken by the user, video of the user interacting with the experience) are stored locally in a local asset store 208. Video segments and/or other content are displayed to the user via output devices 210, such as a video display device and/or speakers. Input devices 212 are used by the user to provide input to the runtime engine 206. Examples of input devices 212 include without limitation a microphone, which may be used, for example, to capture a response spoken by the user in response to a question or other prompt by the video persona, and a touch screen or other haptic device, which may be used to receive as input user selection from among a displayed set of responses, as described more fully below. A user-facing camera 214 in various embodiments provides (or optionally provides) video of the user interacting with the conversational video experience, for example to be used to evaluate and fine-tune the experience for the benefit of future users, to provide picture-in-picture (PIP) capability, and/or to capture the user's side of the conversation, e.g., to enable the user to save and/or share video representing both sides of the conversation.

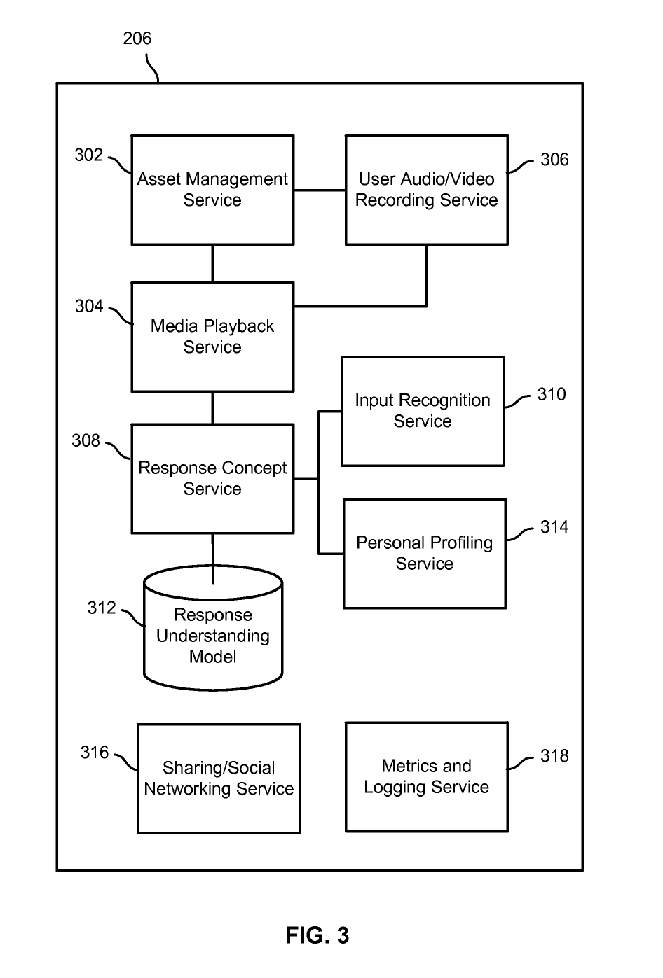

FIG. 3 is a block diagram illustrating an embodiment of a conversational video runtime engine. In various embodiments, a conversational video runtime engine may contain some or all of the components shown in FIG. 3. In the example shown, the conversational video runtime engine 206 includes an asset management service 302. In various embodiments, asset management service 302 manages the retrieval and caching of all required assets (e.g. video segments, language models, etc.) and makes them available to other system components, such as and without limitation media playback service 304. Media playback service 304 in various embodiments plays video segments representing the persona's verbal and physical activity. The video segments in various embodiments are primarily pre-recorded, but in other embodiments may be synthesized on-the-fly. A user audio/video recording service 306 captures and records audio and video of the user during a conversational video experience, e.g., for later sharing and analysis.

In the example shown in FIG. 3, a response concept service 308 determines which video segments to play at which time and in which order, based for example on one or more of user input (e.g., spoken and/or other response); user profile and/or other information; and/or meta-information associated with the conversational video experience.

A input recognition service 310 includes in various embodiments a speech recognition system (SR) and other input recognition such as speech prosody recognition, recognition of user's facial expressions, recognition/extraction of location, time of day, and other environmental factors/features, as well as user's touch gestures (utilizing the provided graphical user interface). The input recognition service 310 in various embodiments accesses user profile information retrieved, captured, and/or generated by the personal profiling service 314, e.g., to utilize personal characteristics of the user in order to adapt the results to the user. For example, if it's understood that the user is male, from their personal profiling data, in some embodiments video segments including any questions regarding the gender of the individual may be skipped, because the user's gender is known from their profile information. Another example is modulating foul language based on user preference: Assuming you have two versions of the conversation, where one version makes use of swear words, and another version that does not, in some embodiments user profile data may be used to choose which version of the conversation is used based on the user's history of swearing (or not) during the course of the user's own statements during the user's participation in the same or previous conversations, making the conversation more enjoyable, or at least more suited to the user's comfort with such language, overall. As a third example, the speech recognizer as well as natural language processor can be made more effective by tuning based on end-user behavior. The current state-of-the-art speech recognizers do allow a user based profile to be built to improve overall speech recognition accuracy on a per-user basis. The output of the input recognition service 310 in various embodiments may include a collection of one or more feature values, including without limitation speech recognition values (hypotheses, such a ranked and/or scored set of “n-best” hypotheses as to which words were spoken), speech prosody values, facial feature values, etc.

Personal profiling service 314 in various embodiments maintains personalized information about a user and retrieves and/or provides that information on demand by other components, such as the response concept service 308 and the input recognition service 310. In various embodiments, user profile information is retrieved, provided, and/or updated at the start of the conversation, as well as prior to each turn of the conversation. In various embodiments, the personal profiling service 314 updates the user's profile information at the end of each turn of the conversation using new information extracted from the user response and interpreted by the response concept service 308. For example, if a response is mapped to a concept that indicates the marital status of user, a profile data may be updated to reflect what the system has understood the user's marital status to be. In some embodiments, a confirmation or other prompt may be provided to the user, to confirm information prior to updating their profile. In some embodiments, a user may clear from their profile information that has been added to their profile based on their responses in the course of a conversational video experience, e.g., due to privacy concerns and/or to avoid incorrect assumptions in situations in which multiple different users use a shared device.

In various embodiments, response concept service 308 interprets output of the input recognition service 310 augmented with the information retrieved by the personal profiling service 314. Response concept service 308 performs interpretation in the domain of natural language (NL), speech prosody and stress, environmental data, etc. Response concept service 308 utilizes one or more response understanding models 312 to map the input feature values into a “response concept” determined to be the concept the user intended to communicate via the words they uttered and other input (facial expression, etc.) they provided in response to a question or other prompt (e.g. “Yup”, “Yeah”, “Sure” or nodding may all map to an “Affirmative” response concept). The response concept service 308 uses the response concept to determine the next video segment to play. For example, the determined response concept in some embodiments may map deterministically or stochastically to a next video segment to play. The output of the response concept service 308 in various embodiments includes an identifier indicating which video segment to play next and when to switch to the next segment.

Sharing/social networking service 316 enables a user to posts aspects of conversations, for example video recordings or unique responses, to sharing services such as social networking applications.

Metrics and logging service 318 records and maintains detailed and summarized data about conversations, including specific responses, conversation paths taken, errors, etc. for reporting and analysis.

The services shown in FIG. 3 and described above may in various embodiments reside in part or in their entirety either on the client device of the human participant (e.g. a mobile device, a personal computer) or on a cloud-based server. In addition, any service or asset required for a conversation may be implemented as a split resource, where the decision about how much of the service or asset resides on the client and how much on the server is made dynamically based on resource availability on the client (e.g. processing power, memory, storage, etc.) and across the network (e.g. bandwidth, latency, etc.). This decision may be based on factors such as conversational-speed response and cost. In some embodiments, for example, input recognition service 310 may invoke a cloud-based speech recognition service, such as those provided by Google® and others, to obtain a set of hypotheses of which word(s) the user has spoken in response to a question or other prompt by a video persona.

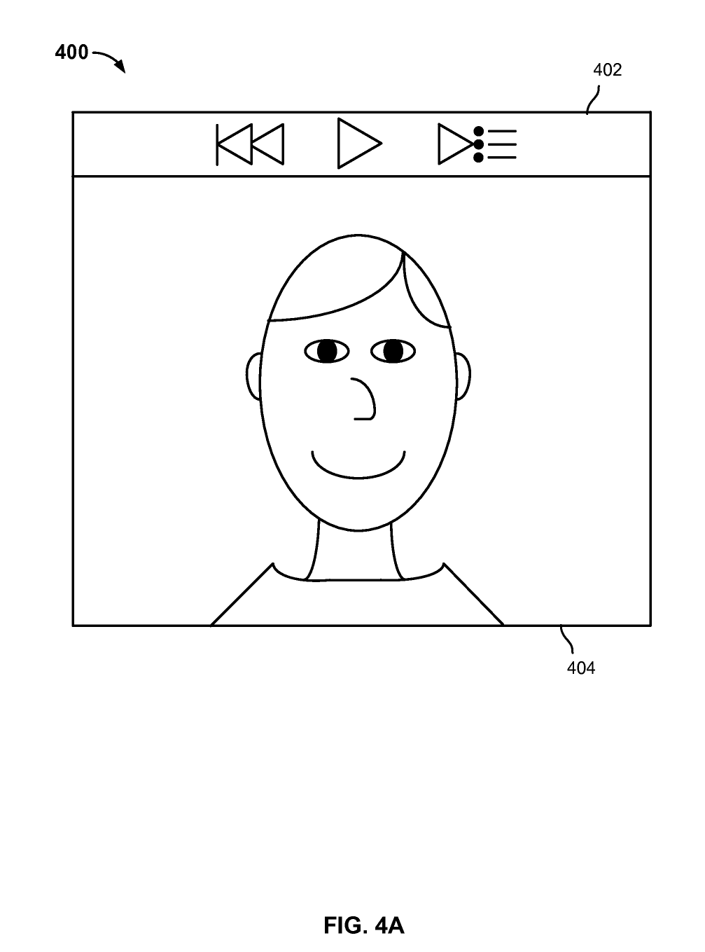

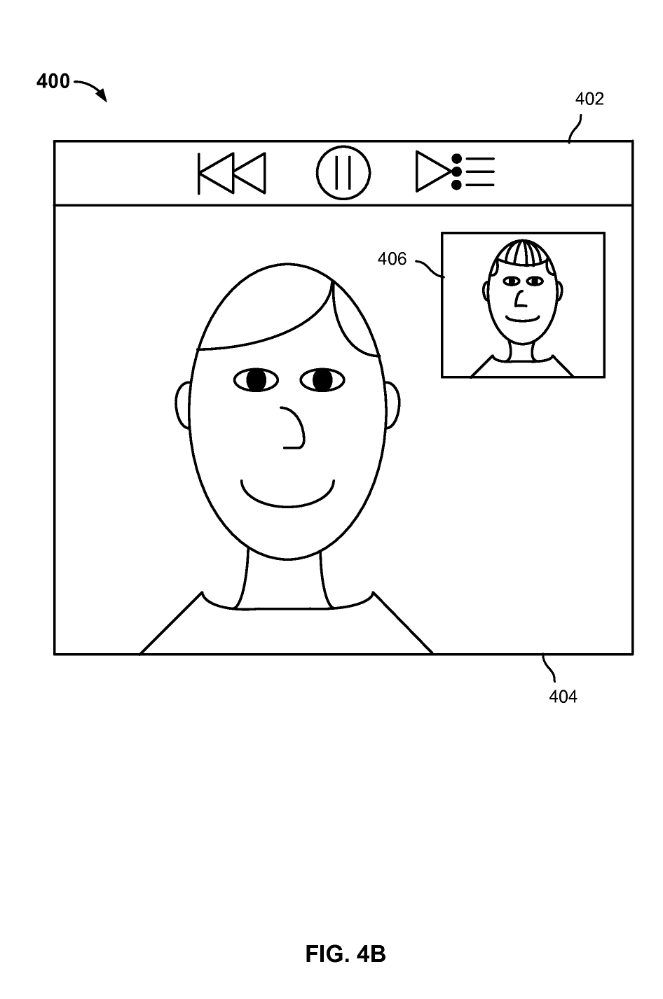

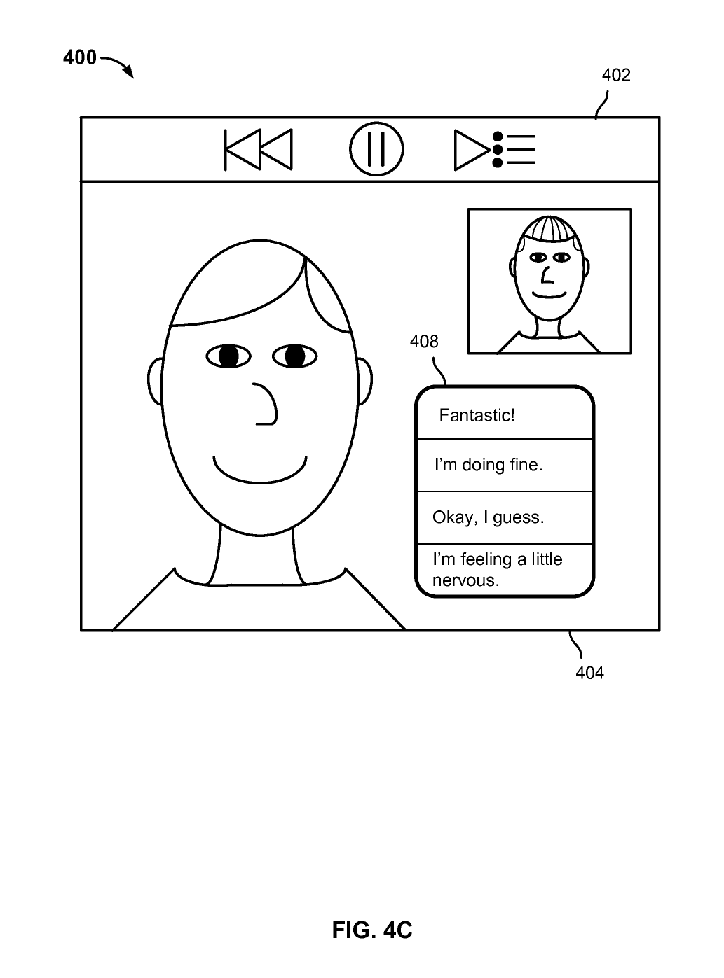

FIG. 4A is a block diagram illustrating an embodiment of a conversational video experience display and interface. In the example shown, a display 400 includes a control panel region 402 and a conversational video experience display region 404. In some embodiments, control panel region 402 is displayed and/or active only at certain times and/or conditions, e.g., once a video segment has finished playing, upon mouse-over or other pre-selection, etc. In the example shown, control panel region 402 includes three user selectable controls: at left a “rewind” control to iterate back through previously-played segments and/or responses; in the center a “play” control to indicate a readiness and desire to have a current/immediately next segment played; and at right a “forward” control, e.g., to cause a list of user-selectable responses or other user-selectable options available to advance the conversational video experience to be displayed. In the video experience display region 404, a video segment of a video persona engaged in her current “turn” of the conversation is displayed. In the example shown, a title/representative frame, or a current/next frame, of the current/next video segment is displayed, and selection of the “play” control would cause the video segment to begin (and/or resume) to play.

FIG. 4B is a block diagram illustrating an embodiment of a conversational video experience display and interface. In the example shown in FIG. 4B, the “play” control in the center of control panel region 402 has been replaced by a “pause” control, indicating in some embodiments that the current video segment of the video persona is currently playing. In addition, a picture-in-picture (PIP) frame 406 has been added to conversational video experience display region 404. In this example, video of the user of a client device comprising display 400 is displayed in PIP frame 406. A front-facing camera of the client device may be used in various embodiments to capture and display in PIP frame 406 video of a user of the client device while he/she engages with the conversational video experience. Display of user video may enable the user to ensure that the lighting and other conditions are suitable to capture user video of desired quality, for example to be saved and/or shared with others. In some embodiments, upon expiration of a prescribed time after the video persona finishes expressing a question or other prompt, a speech balloon or bubble may be displayed adjacent to the PIP frame 406, e.g., with a partially greyed out text prompt informing the user that it is the user's turn to speak.

The system in various embodiments provides dynamic hints to a user of which input modalities are made available to them at the start of a conversation, as well as in the course of it. The input modalities can include speech, touch or click gestures, or even facial gestures/head movements. The system decides in various embodiments which one should be hinted to the user, and how strong a hint should be. The selection of the hints may be based on environmental factors (e.g. ambient noise), quality of the user experience (e.g. recognition failure/retry rate), resource availability (e.g., network connectivity) and user preference. The user may disregard the hints and continue using a preferred modality. The system keeps track of user preferences for the input modalities and adapts hinting strategy accordingly.

The system can use VUI, touch-/click-based GUI and camera-based face image tracking to capture user input. The GUI is also used to display hints of what modality is preferred by the system. For speech input, the system displays a “listening for speech” indicator every time the speech input modality becomes available. If speech input becomes degraded (e.g. due to a low signal to noise ratio, loss of an access to a remote SR engine) or the user experiences a high recognition failure rate, the user will be hinted at/reminded of the touch based input modality as an alternative to speech.

The system hints (indicates) to the user that the touch based input is preferred at this point in the interactions by showing an appropriate touch-enabled on-screen indicator. The strength of a hint is expressed as the brightness and/or the frequency of pulsation of the indicator image. The user may ignore the hint and continue using the speech input modality. Once the user touches that indicator, or if the speech input failure persists, the GUI touch interface becomes enabled and visible to the user. The speech input modality remains enabled concurrently with the touch input modality. The user can dismiss the touch interface if they prefer. Conversely, the user can bring up the touch interface at any point in the conversation (by tapping an image or clicking a button). The user input preferences are updated as part of the user profile by the PP system.

For touch input, the system maintains a list of pre-defined responses the user can select from. The list items are response concepts, e.g., “YES”, “NO”, “MAYBE” (in a text or graphical form). These response concepts are linked one-to-one with the subsequent prompts for the next turn of the conversation. (The response concepts match the prompt affirmations of the linked prompts.) In addition, each response concept is expanded into a (limited) list of written natural responses matching that response concept. As an example, for a prompt “Do you have a girlfriend?” a response concept “NO GIRLFRIEND” may be expanded into a list of natural responses “I don't have a girlfriend”, “I don't need a girlfriend in my life”, “I am not dating anyone”, etc. A response concept “MARRIED” may be expended into a list of natural responses “I'm married”, “I am a married man”, “Yes, and I am married to her”, etc.

FIG. 4C is a block diagram illustrating an embodiment of a conversational video experience display and interface. In the example shown, a list of response concepts is presented via a touch-enabled GUI popup window 408. The user can apply a touch gesture (e.g., tap) to a response concept item on the list, and in response the system will start playing a corresponding video segment of the video persona. In some embodiments, the user can apply another touch gesture (e.g., double-tap) to the response concept item to make the item expand into a list of natural responses (in text format). In some embodiments, this new list will replace the response concept list in the popup window. In another implementation, the list of natural responses is shown in another popup window. The user can use touch gestures (e.g., slide, pinch) to change the position and/or the size of the popup window(s). The user can apply a touch gesture (e.g., tap) to a natural response item to start playing the corresponding video prompt. To go back to the list of response concepts or dismiss a popup window, the user can use other touch gestures (or click on a GUI button).

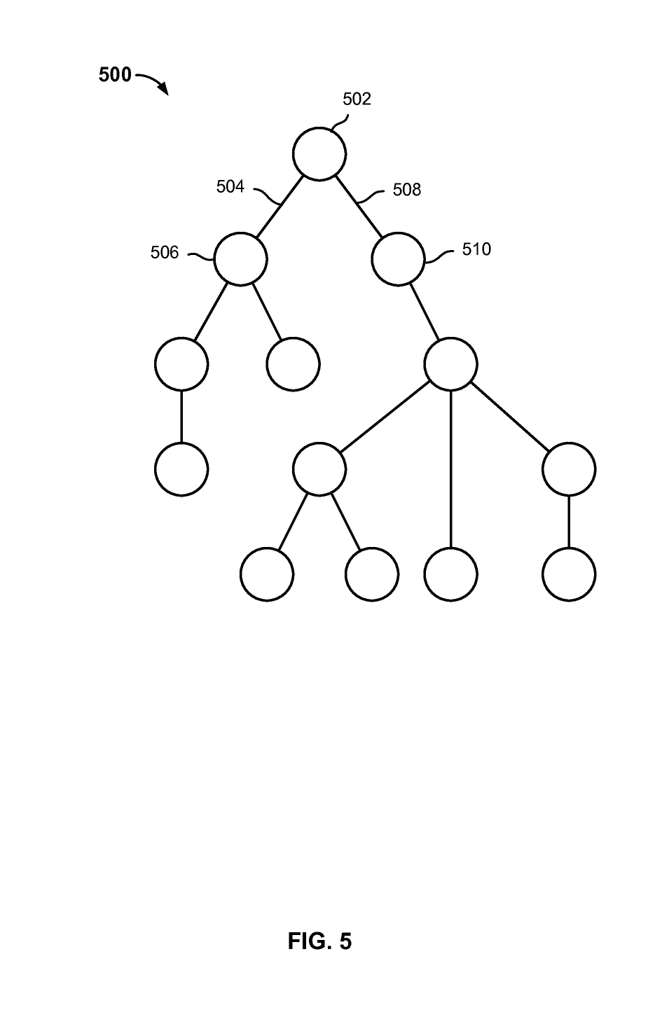

FIG. 5 is a block diagram illustrating an embodiment of a conversational video experience. In the example shown, a conversational video experience is represented as a tree 500. An initial node 502 represents an opening video segment, such as a welcoming statement and initial prompt by a video persona. In the example shown, the conversation may after the initial segment 502 follow one or two next paths. The system listens to the human user's spoken (or other) response and maps the response to either a first response concept 504 associated with a next segment 506 or to a second response concept 508 associated with a next segment 510. Depending on which response concept the user's input is mapped to, in this example either response concept 504 or response concept 508, a different next video segment (i.e., segment 506 or segment 510) will be played next. In various embodiments, a conversational experience may be represented as a directed graph, and one or more possible paths through the graph may converge at some node in the graph, for example, if respective response concepts from each of two different nodes map/link to a common next segment/node in the graph.

In various embodiments, a primary function within the runtime engine is a decision-making process to drive conversation. This process is based on recognizing and interpreting signals from the user and selecting an appropriate video segment to play in response. The challenge faced by the system is guiding the user through a conversation while keeping within the domain of the response understanding model(s) and video segments available.

For example, in some embodiments, the system may play an initial video segment representing a question posed by the virtual persona. The system may then record the user listening/responding to the question. A user response is captured, for example by an input response service, which produces recognition results and passes them to a response concept service. The response concept service uses one or more response understanding models to interpret the recognition results, augmented in various embodiments with user profile information. The result of this process is a “response concept.” For example, recognized spoken responses like “Sure”, “Yes” or “Yup” may all result in a response concept of “AFFIRMATIVE”.

The response concept is used to select the next video segment to play. In the example shown in FIG. 5, each response concept is deterministically associated with a single video segment. In some embodiments, each node in the tree, such as tree 500 of FIG. 5, has associated therewith a node-specific response understanding model that may be used to map words determined to have been uttered and/or other input provided in response to that segment to one or more response concepts, which in turn may be used to select a next video segment to be presented to the user.

The video segment and the timing of the start of a response are passed in various embodiments to a media playback service, which initiates video playback of the response by the virtual persona at an indicated and/or otherwise determined time.

In various embodiments, the video conversational experience includes a sequence of conversation turns such as those described above in connection with FIG. 5. In one embodiment of this type of conversation, all possible conversation turns are represented in the form of a pre-defined decision tree/graph, as in the example shown in FIG. 5, where each node in the tree/graph represents a video segment to play, a response understanding model to map recognized and interpreted user responses to a set of response concepts, and the next node for each response concept.

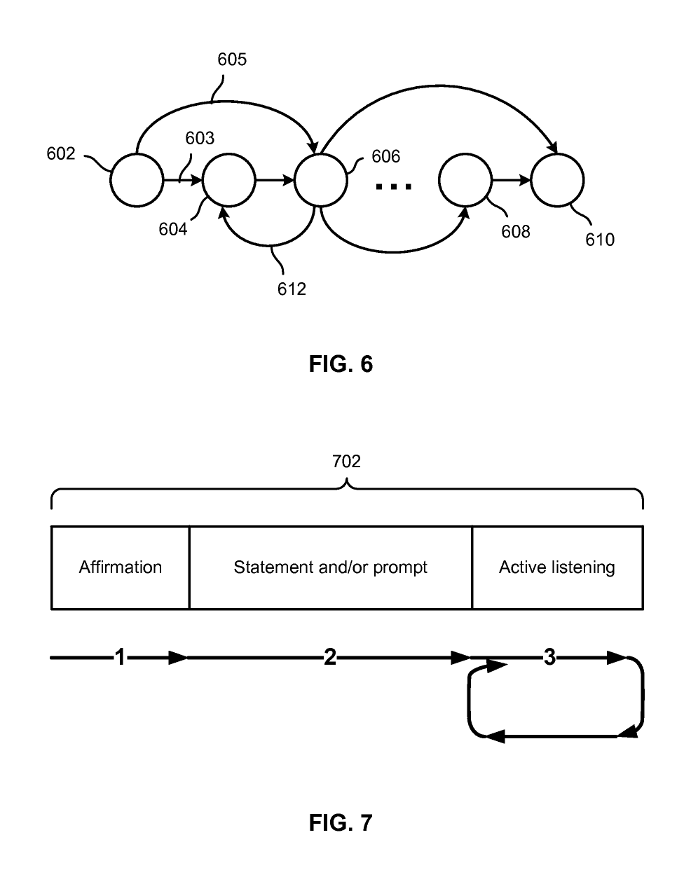

FIG. 6 is a block diagram illustrating an embodiment of a conversational video experience. In FIG. 6, a less hierarchical representation of a conversation is shown. In the example shown, from an initial node/segment 602, a user response that is mapped to a first response concept 603 results in a transition to node/segment 604, whereas a second response concept 605 would cause the conversation to leap ahead to node/segment 606, bypassing node 604. Likewise, from node 606 the conversation may transition via one response concept to node 608, but via a different response concept directly to node 610. In the example shown, a transition “back” from node 606 to node 604 is possible, e.g., in the case of a user response that is mapped to response concept 612.

In some embodiments, to enable a more natural and dynamic conversation, each conversational turn does not have to be pre-defined. To make this possible, the system in various embodiments has access to one or more of:
A corpus of video segments representing a large set of possible prompts and responses by the virtual persona in the subject domain of the conversation.
A domain-wide response understanding model in the subject domain of the conversation. In various embodiments, the domain-wise response understanding model is conditioned at each conversational turn based on prompts and responses adjacent to that point in the conversation. The response understanding model is used, as described above, to interpret user responses (deriving one or more response concepts based on user input). It is also used to select the best video segment for the next dialog turn, based on highest probability interpreted meaning.

An example process flow in such a scenario includes the following steps:
At the start of the conversation, a pre-selected opening prompt is played.
After playing the selected prompt, the user response is captured, speech recognition is performed, and the result is used to determine a response concept. The response understanding model may be updated (conditioned) based on the user response.
The conditioned response understanding model is used to select the best possible available video segment as the prompt to play next, representing the virtual persona's response to the user response described in immediately above. To make that selection, each available prompt is passed to the conditioned response understanding model, which generates a list of possible interpretations of that prompt, each with a probability of expressing the meaning of the prompt. The highest-probability interpretation defines the best meaning for the underlying prompt and serves as its best-meaning score. In principle, an attempt may be made to interpret every prompt recorded for a given video persona in the domain of the conversation, and select the prompt yielding the highest best-meaning score. This selection of the next prompt represents the start of the next conversational turn. It starts by playing a video segment representing the selected prompt.
For each conversational turn, the response understanding model can be reset to the domain-wide response understanding model and the steps described above are repeated. This process continues until the user ends the conversation, the system selects a video segment that is tagged as a conversation termination point, or the currently conditioned response understanding model determines that the conversation has ended.

The above embodiments exemplify different methods through which the runtime system can guide the conversation within the constraints of a finite and limited set of available understanding models and video segments.

A further embodiment of the runtime system utilizes speech and video synthesis techniques to remove the constraint of responding using a limited set of pre-recorded video segments. In this embodiment, a response understanding model can generate the best possible next prompt by the virtual persona within the entire conversation domain. The next step of the conversation will be rendered or presented to the user by the runtime system based on dynamic speech and video synthesis of the virtual persona delivering the prompt.

### Active Listening

To maintain a user experience of a natural conversation, in various embodiments the video persona maintains its virtual presence and responsiveness, and provides feedback to the user, through the course of a conversation, including when the user is speaking. To accomplish that, in various embodiments appropriate video segments are played when the user is speaking and responding, giving the illusion that the persona is listening to the user's utterance.

FIG. 7 is a block diagram illustrating an embodiment of a conversational video experience segment. In the example shown, a video segment 702 includes three distinct portions. In a first portion, labeled “affirmation” in FIG. 7, the video persona provides feedback to indicate that the user's previous response has been heard and understood. For example, if the user has uttered a response that has been mapped to the response concept “feeling good”, the video persona might during the affirmation portion of the segment that is selected to play next say something like, “That's great, I'm feeling pretty good today too.” In the next portion, labeled “statement and/or prompt” in FIG. 7, the video persona may communicate information, such as to inform the user, provide information the user may be understood to have expressed interest in, etc., and either explicitly (e.g., by asking a question) or implicitly or otherwise prompt the user to provide a response. While the video persona waits for the user to respond, an “active listening” portion of the video segment 702 is played. In the example shown, if an end of the active listening portion is reached before the user has completed providing a response, the system loops through the active listening portion again, and if necessary through successive iterations, until the user has completed providing a response.

In one embodiment, active listening is simulated by playing a video segment (or portion thereof) that is non-specific. For example, the video segment could depict the virtual persona leaning towards the user, nodding, smiling or making a verbal acknowledgement (“OK”), irrespective of the user response. Of course, this approach risks the possibility that the virtual persona's reaction is not appropriate for the user response.

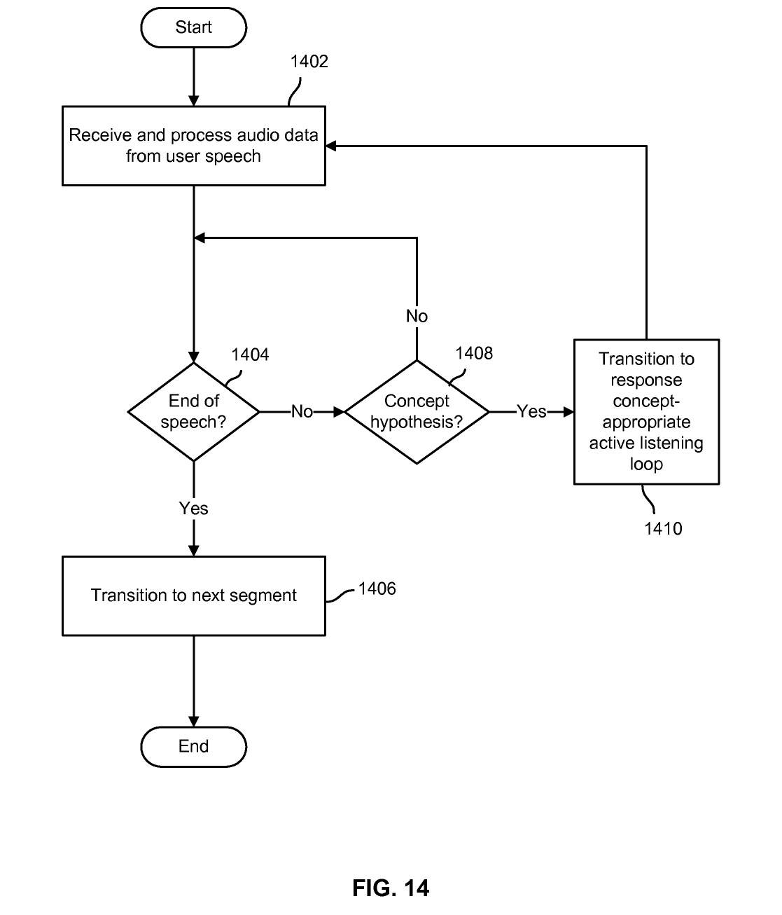

In another embodiment of the process, the system selects an appropriate active listening video segment based on the best current understanding of the user's response, as discussed more fully below in connection with FIG. 14.

The system can allow a real user to interrupt a virtual persona, and will simulate an “ad hoc” transition to an active listening shortly after detection of such interruption after selecting an appropriate “post-interrupted” active listening video segment (done within the response concept service system).

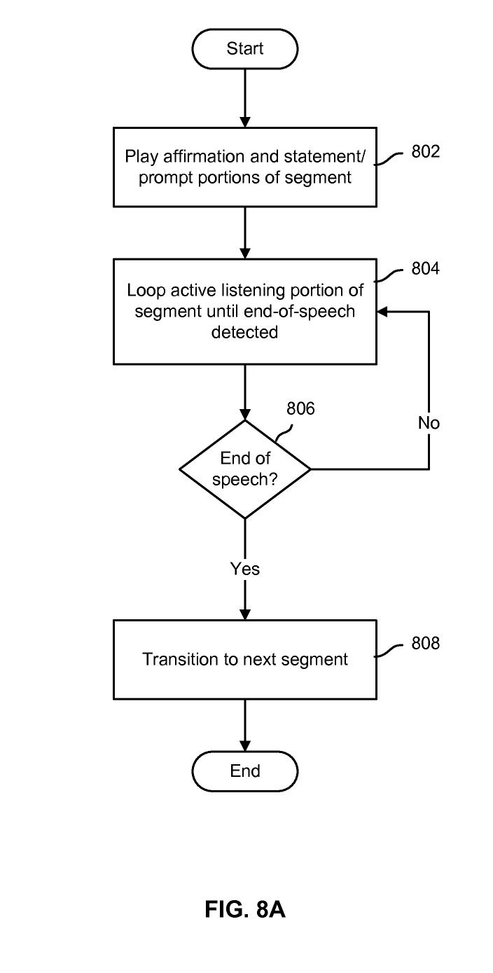

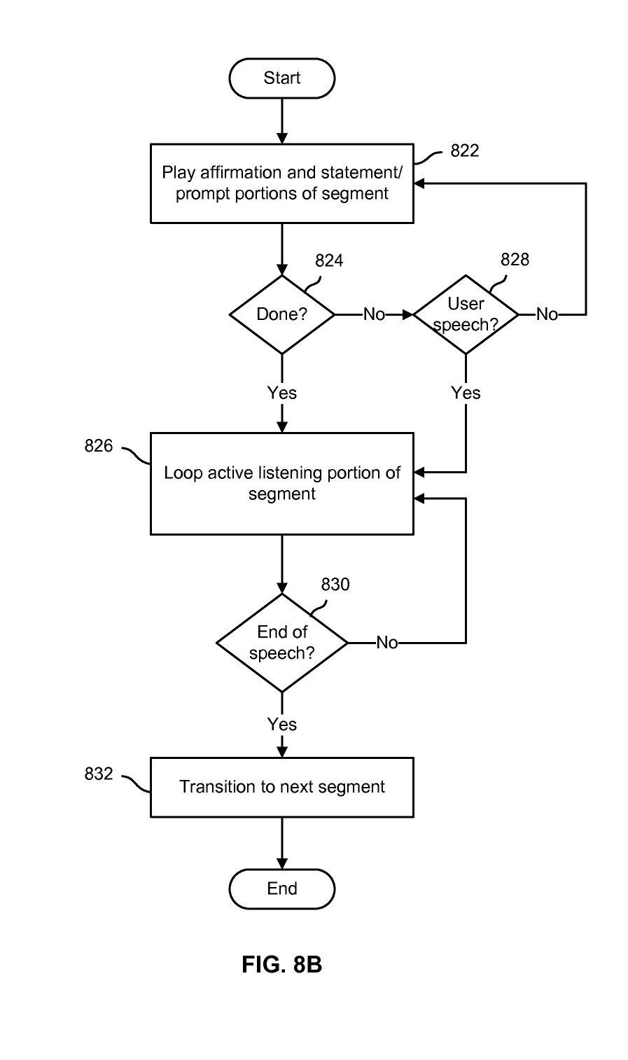

FIG. 8A is a flow chart illustrating an embodiment of a process to provide a conversational video experience. In the example shown, affirmation and statement/prompt portions of a segment are played (802). An active listening portion of the segment is looped, until end-of-speech by the user is detected (804). Once end of user speech is detected (806), the user's response is determined (e.g., speech recognition) and mapped to a response concept, enabling transition to a next segment (808), e.g., one associated with the response concept to which the user's spoken response has been mapped.

In some embodiments, the system can allow a real user to interrupt a virtual persona, and will simulate an “ad hoc” transition to an active listening mode shortly after detection of such interruption after selecting an appropriate “post-interrupted” active listening video segment.

FIG. 8B is a flow chart illustrating an embodiment of a process to provide a conversational video experience. In the example shown, affirmation and statement/prompt portions of a segment are played (822). If the affirmation and statement/prompt portions play to the end of those portions (824), an active listening portion of the segment is looped (826), until end-of-speech by the user is detected (830). If, instead, the user begins to speak during playback of the affirmation and statement/prompt portions of the segment (828), then playback of the affirmation and statement/prompt portions of the segment ends without completing playback of those portions, and an immediate transition to looping the active listening portion of the segment is made (826). Once the end of the user's speech is reached (830), the system transitions to the next segment (832).

### Receiving and Interpreting User Responses

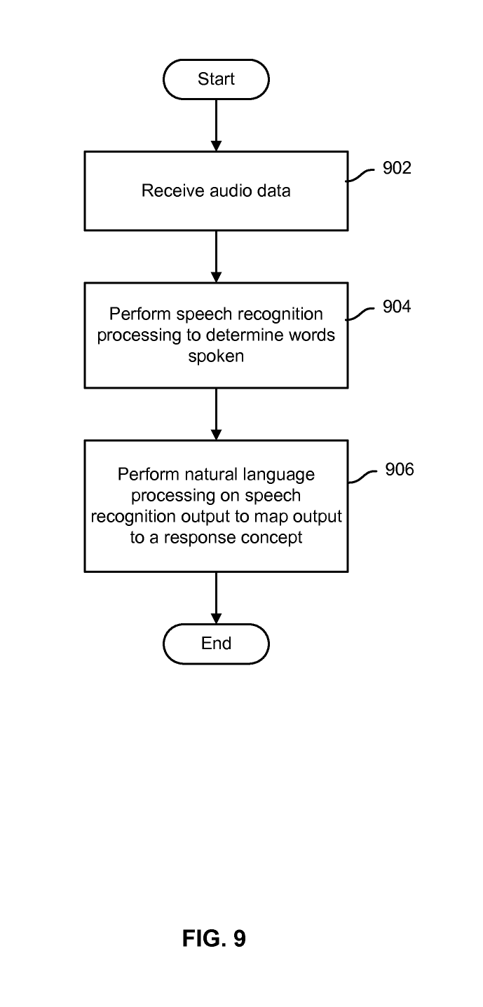

FIG. 9 is a flow chart illustrating an embodiment of a process to receive and interpret user responses. In the example shown, audio data is received (902). For example, in some embodiments, when the beginning of user speech is detected and/or once the video playback has entered into active listening mode, the client device's microphone is activated, and audio captured by the microphone is streamed to a cloud-based or other speech recognition service (904). Natural language processing is performed on results of the speech recognition processing, e.g., an n-best or other set of hypotheses, to map the results to one or more “response concepts” (906).

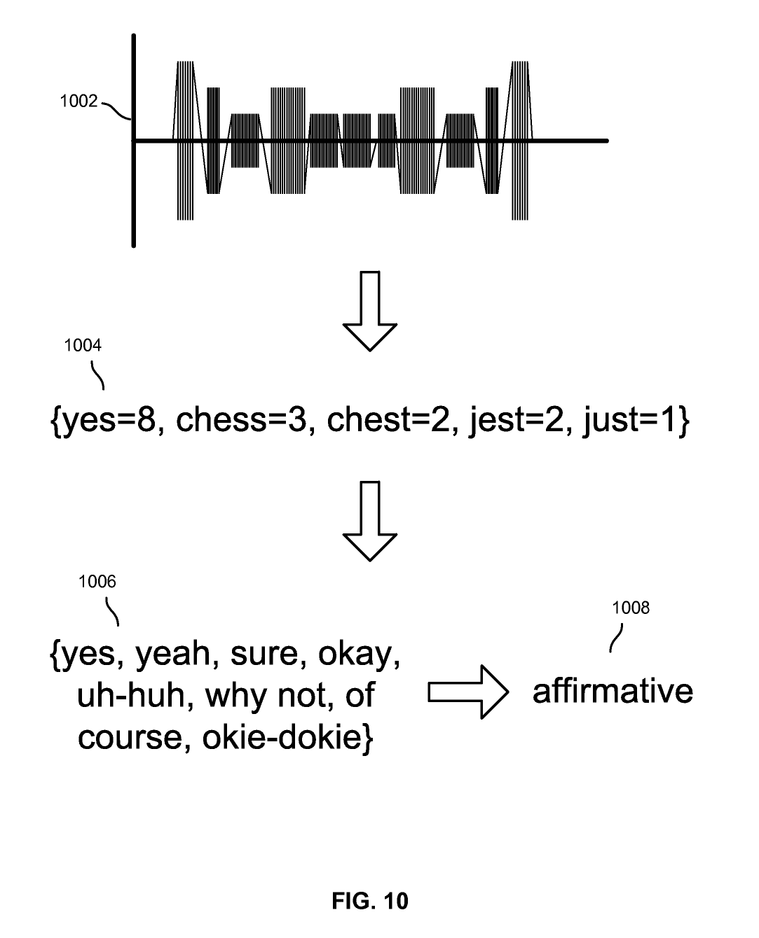

FIG. 10 is a block diagram illustrating an embodiment of elements of a conversational video experience system. In the example shown, audio data comprising user speech 1002 is provided to a speech recognition local and/or remote module and/or service to obtain a speech recognition output 1004 comprising a set of n-best hypotheses determined by the speech recognition service as the most likely words that were uttered. In the example shown each member of the set has an associated score, but in other embodiments a confidence or other score for the entire set is provided, with members of the set being presented in ranked order. The speech recognition output 1004 is provided as input to a natural language processing module and/or service, which in the example shown attempts to match the speech recognition output 1004 to a response understanding model 1006 to determine a response concept 1008 that the user is determined to have intended and/or in some embodiments which is the response concept most likely to be associated with the user's spoken and/or other responsive input. In the example shown, the spoken utterance has been determined by speech recognition processing to most likely have been the word “yes”, which in turn has been mapped to the response concept “affirmative”. While words represented as text are included in the response understanding model 1006 as shown in FIG. 10, in various embodiments other input, such as selection by touch or otherwise of a displayed response option, nodding of the head, etc., may also and/or instead be included.

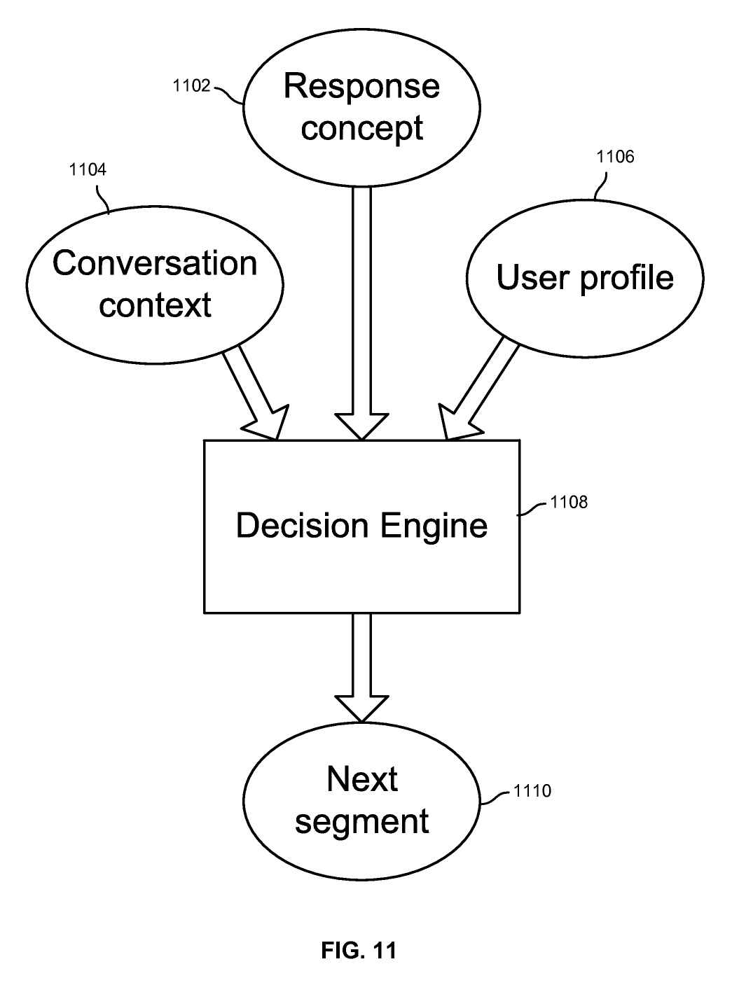

FIG. 11 is a block diagram illustrating an embodiment of a conversational video experience next segment decision engine. In the example shown, one or more of user responsive input that has been mapped to an associated response concept 1102, conversation context data 1104 (e.g., where the most recently played video segment is located within a set of nodes comprising the conversational video experience; what the user has said or otherwise provided as input in the course of the experience; etc.), and user profile data 1106 are provided to a decision engine 1108 configured to identify and provide as output a next segment 1110 based at least in part on the inputs 1102, 1104, and/or 1106.

In various embodiments, the input (e.g., speech) recognition service accesses, and the response concept service integrates, all relevant information sources to support decision-making necessary for selection of a meaningful, informed and entertaining response as a video segment (e.g., from a collection of pre-recorded video segments representing the virtual persona asking questions and/or affirming responses by the user). By using context beyond a single utterance of the user, in various embodiments the system can be more responsive, more accurate in its assessment of the user's intent, and can more accurately anticipate future requests.

Examples of information gathered through various sources may include, without limitation, one or more of the following:
A priori knowledge of the user based on his or her identity. Examples of such knowledge include information about the user's interests, contacts and recent posts from the user's social network; gender or demographic information from a customer information database; name and address information from a prior registration process.
Information gathered by the runtime system based on prior experience within the system, even across conversations with different virtual personae. Examples of such information could include responses to prior questions such as “Are you married?”, “What kind of pet do you have?”, etc. or others that suggest interest and intent.
Information provided by the container application of the runtime engine. This can provide the context of application domain and activity prior to entering a conversation.
Extrinsic inputs collected by sensors available to the system. This could include time-of-day, current location, or even current orientation of the client device.
Facial recognition and expressions collected by capturing and interpreting video or still images of the user through a camera on the client device.

In various embodiments, the above information may be used in isolation or in combination to provide a better conversational experience, for example, by:
Providing a greater number of input features to the input recognition and/or response concept services to carry out more accurate recognition, understanding and decision-making. For example, recognition that the user is nodding would help the system interpret the utterance “uh-huh” as an affirmative response. Or the statement “I went boarding yesterday” could be disambiguated based on a recent post on a social network made by the same user describing a skateboarding activity.
Allowing the runtime engine to skip entire sections of the conversation that were originally designed to collect information that is already known. For example, if a conversation turn was originally built to determine whether the user is married, this turn could be skipped if the marital status of the user was determined in a previous conversation or from an existing user profile database.
Allowing the runtime engine to select video segments solely based on extrinsic inputs. For example, the virtual persona may start a conversation with “Good morning!” or “Good evening!” based on the time that the conversation is started by the user.

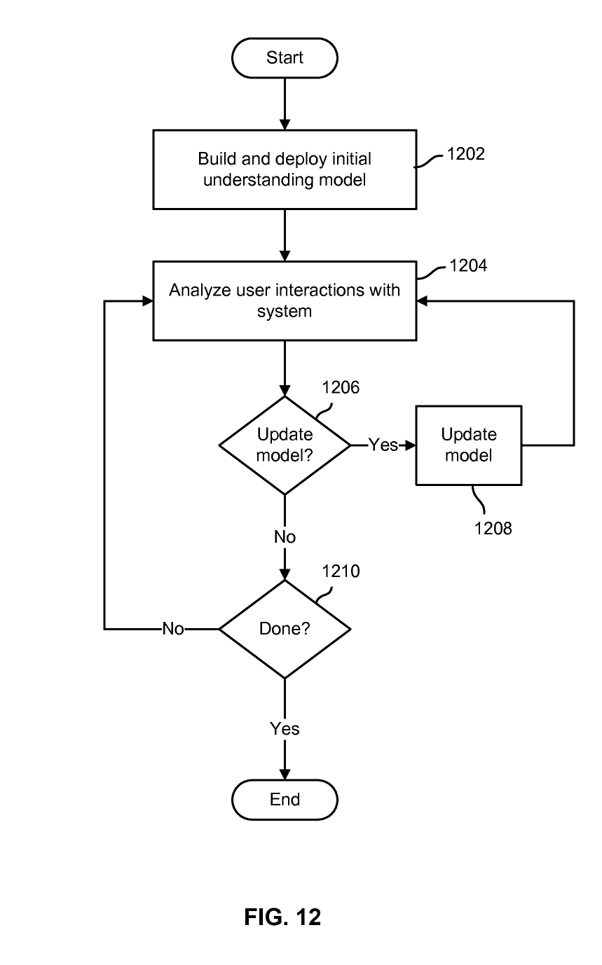

FIG. 12 is a flow chart illustrating an embodiment of a process to provide and update a response understanding model. In the example shown, an initial understanding model is built and deployed (1202). For example, in some embodiments, a designer of the conversation video experience may decide in the course of initial design of the conversational video experience which concepts may be expressed by a user in response to a question or other prompt by the video persona. For each concept, the designer may attempt to anticipate words and phrases a user might utter, in response to a question or other prompt by the video persona via a video segment associated with the node, and for each a concept to which that word or phrase is to be mapped. Once the understanding model is deployed (1202), user interactions with the system are monitored and analyzed to determine whether any updates to the model are required and/or would be beneficial to the system (1204). For example, in various embodiments the interaction of test users and/or real users with the conversational video experience may be observed, and words or phrases used by such users but not yet mapped to a concept may be added and mapped to corresponding concepts determined to have been intended by such users. Additional words or phrases may be mapped to existing concepts conceived of by the designer, or in some embodiments, new concepts may be determined and added, and associated paths through the conversational video experience defined, in response to such observation of user interactions with the experience. In various embodiments, model refinements may be identified, initiated, and/or submitted by a participating user; by one or more users acting collectively; by one or more remote workers/users assigned tasks structured to potentially yield model refinements (e.g., crowdsourcing); and/or a designer or other human operator associated with production, maintenance, and/or improvement of the conversational video experience. If an update to the model is determined to be required (1206), the model is updated and the updated model is deployed (1208). The process of FIG. 12 executes continuously unless terminated (1210).

### Conversational Transitions

In various embodiments, mechanisms are provided to handle expected and longer-than-expected transitions, e.g., to handle delays in deciding what the virtual persona should say next without destroying the conversational feel of the application. Such delays can come from a number of sources, such as the need to retrieve assets from the cloud, the computational time taken for analysis, and other sources. Depending on the circumstances, the detection of a delay may be determined immediately prior to requiring the asset or analysis result that is the source of the delay, or it may instead be determined well in advance of requiring the asset (for example, if assets were being progressively downloaded in anticipation of their use and there were a network disruption).

One approach is to use transitional conversational segments, transitional in that they delay the need for the asset being retrieved or the result which is the subject of the analysis causing the delay. These transitions can be of several types:

Neutral: Simple delays in meaningful content that would apply in any context, e.g., “Let me see . . . ,” “That's a good question . . . ,” “That's one I'd like to think about . . . Hold on, I'm thinking,” or something intended to be humorous. The length of the segment could be in part determined by the expected delay.

Application contextual: The transition can be particular to the application context, e.g., “Making financial decisions isn't easy. There are a lot of things to consider.”

Conversation contextual: The transition could be particular to the specific point in the conversation, e.g., “The show got excellent reviews,” prior to indicating ticket availability for a particular event.

Additional information: The transition could take advantage of the delay to provide potentially valuable additional content in context, without seeming disruptive to the conversation flow, e.g., “The stock market closed lower today,” prior to a specific stock quote.

Directional: The system could direct the conversation down a specific path where video assets are available without delay. This decision to go down this conversation path would not have been taken but for the aforementioned detection of delay.

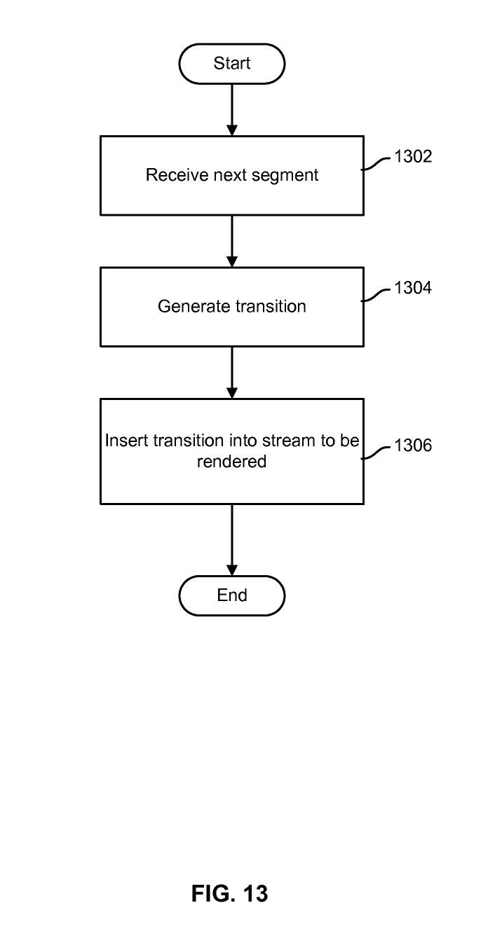

FIG. 13 is a flow chart illustrating an embodiment of a process to integrate a transition video into a conversation video experience. In the example shown, a transition may be generated and inserted dynamically, e.g., in response to determining programmatically that a delay will prevent timely display of a next segment and/or in embodiments in which a next segment may be obtained and/or synthesized dynamically, in real time, based for example on the user's response to the previously-played segment. In some embodiments, the process of FIG. 13 may be used at production time to create transition clips or portions thereof. In the example shown, a next segment to which a transition from a previous/current segment is required is received (1302). A transition is generated and/or obtained (1304) and inserted into the video stream to be rendered to the user (1306).

In various embodiments, one or more techniques may be used to enable a smooth transition of a virtual persona's face/head image between video segments for an uninterrupted user experience. The ideal case is if the video persona moves smoothly. In various embodiments, it is a “talking head.” There is no problem if a whole segment of the video persona speaking is recorded continuously. But there may be transitions between segments where that continuity is not guaranteed. Thus, there is a general need for an approach to smoothly blending two segments of video, with a talking head as the implementation we will use to explain the issue and its solution.

One approach is to record segments where the end of the segment ends in a pose that is the same as the pose at the beginning of a segment that might be appended to the first segment. (Each segment might be recorded multiple times with the “pose” varied to avoid the transition being overly “staged.”) When the videos are combined as part of creating a single video for a particular segment of the interaction (as opposed to being concatenated in real time), standard video processing techniques can be used to make the transition appear seamless, even though there are some differences in the ending frame of one segment and the beginning of the next.

Depending on the processor of the device on which the video is appearing, those same techniques (or variations thereof) could be used to smooth the transition when the next segment is dynamically determined. However, methodology that makes the transition smoothing computationally efficient is desirable to minimize the burden on the processor. One approach is the use of “dynamic programming” techniques normally employed in applications such as finding the shortest route between two points on a map, as in navigation systems, combined with facial recognition technology. The process proceeds roughly as follows:
Identify key points on the face using facial recognition technology that we focus on when recognizing and watching faces, e.g., the corners of the mouth, the center of the eyes, the eyebrows, etc. Find those points on both the last frame of the preceding video segment and the first frame of the following video segment.
Depending on how far apart corresponding points are in pixels between the two images, determine the number of video frames required to create a smooth transition.
Use dynamic programming or similar techniques to find the path through the transition images to move each identified point on the face to the corresponding point so that the paths are as similar as possible (minimize distortion).
Other points are moved consistently based on their relationship to the points specifically modeled. The result is a smooth transition that focuses on what the person watching will be focusing on, resulting in reduced processing requirements.

In various embodiments techniques described herein are applied with respect to faces. Only a few points on the face need be used to make a transformation, yet it will generate a perceived smooth transition. Because the number of points used to create the transformation is few, the computation is small, similar to that required to compute several alternative traffic routes in a navigation system, which we know can be done on portable devices. Facial recognition has similarly been used on portable devices, and Microsoft's Kinect™ game controller recognizes and models the whole human body on a small device.

In various embodiments, transition treatment as described herein is applied in the context of conversational video. There is a need for many transitions relative to some other areas where videos are used for, e.g., instructional purposes, with little if any real variation in content. While some of these applications are characterized as “interactive,” they are little more than allowing branching between complete videos, e.g., to explain a point in more detail if requested. In conversational video, a key component is much more flexibility to allow elements such as personalization and the use of context, which will be discussed later in this document. Thus, it is not feasible to create long videos incorporating all the variations possible and simply choose among them; it will be necessary to fuse shorter segments.

A further demand of interactive conversation with a video persona on portable devices in some embodiments is the limitation on storage. It would not be feasible to store all segments on the device, even if there were not the issue of updates reflecting change in content. In addition, since in some embodiments the system is configured to anticipate segments that will be needed and begin downloading them while one is playing, this encourages the use of shorter segments, further increasing the likelihood that concatenation of segments will be necessary.

FIG. 14 is a flow chart illustrating an embodiment of a process to provide a dynamic active listening experience. In the example shown, user input in the form of a spoken response is received and processed (1402). If an end of speech is reached (1404), the system transitions to a next video segment (1406), e.g., based on the system's best understanding of the response concept with which the user's input is associated. If prior to the end of the user's speech the word or words that have been uttered thus far are determined to be sufficient to map the user's input to a response concept, at least provisionally (1408), the system transitions to a response concept-appropriate active listening loop (1410) and continues to receive and process the user's ongoing speech (1402). For example, a transition from a neutral active listening loop to one that expresses a sentiment and/or understanding such as would be appropriate and/or expected in a conversation between two live humans as a listener begins to understand the speaker's response may be made. Examples include without limitation active listening loops in which the video persona expresses heightened concern, keen interest, piqued curiosity, growing dismay, unease, confusion, satisfaction, agreement or other affirmation (e.g., by nodding while smiling), etc.

To be able to make a decision while the user is speaking, the recognition and understanding of an on-going partially completed response have to be performed and the results made available while the user is in the process of speaking (or providing other, non-verbal input). The response time of such processing should allow a timely selection of a video segment to simulate active listening with appropriate verbal and facial cues.

In various embodiments, the system selects, switches and plays the most appropriate video segment based on (a) an extracted meaning of the user statement so far into their utterance (and an extrapolated meaning of the whole utterance); and (b) an appropriate reaction to it by a would-be human listener. To make the timely selection and switch, it uses information streamed to it from the speech or other input recognition and response concept services. In some embodiments, an on-going partially spoken user response is processed, and the progressively expanding results are used to make a selection of a video segment to play during the active listening phase.

The video segment selected and the time at which it is played can be used to support aspects of the cadence of a natural conversation. For example:
The video could be an active listening segment possibly containing verbal and facial expressions played during the time that the user is making the utterance.
The video could be an affirmation or question in response to the user's utterance, played immediately after the user has completed the utterance.
The system can decide to start playing back the next video segment while the user is still speaking, thus interrupting or “barging-in” to the user's utterance. If the user does not yield the turn and keeps speaking, this will be treated as a user barge-in.

### Multiple Recognizers

To achieve the best speech recognition performance (minimum error rate, acceptable response time and resource utilization), in some embodiments more than a single speech recognition service and/or system may be required. Also, to reduce the cost incurred by interacting with a fee-based remote speech recognition service, it may be desirable to balance its use with a local speech recognition service (embedded in the user device). In various embodiments, at least one local speech recognition service and at least one remote speech recognition service (network based) are included. Several cooperative schemes can be used to enable their co-processing of speech input and delegation of the authority for the final decision/formulation of the results. These schemes are implemented in some embodiments using a speech recognition controller system which coordinates operations of local and remote speech recognition services.

The schemes may include:

(1) Chaining

A local speech recognition service can do a more efficient start/stop analysis, and the results can be used to reduce the amount of data sent to the remote speech recognition service.

(1.1) A local speech recognition service is authorized to track audio input and detect the start of a speech utterance. The detected events with an estimated confidence level are passed as hints to the speech recognition service controller which makes a final decision to engage (to send a “start listening” command to) the remote speech recognition service and to start streaming the input audio to it (covering a backdated audio content to capture the start of the utterance).

(1.2) In addition, a local speech recognition service is authorized to track audio input and detect the end of a speech utterance. The detected events with an estimated confidence level are passed as hints to the speech recognition service controller which makes a final decision to send a “stop listening” command to the remote speech recognition service and to stop streaming the input audio to it (after sending some additional audio content to capture the end of the utterance as may be required by the remote speech recognition service). Alternatively, the speech recognition service controller may decide to rely on a remote speech recognition service for the end of speech detection. Also, a “stop listening” decision can be based on a higher-authority feedback from the response concept service system that may decide that a sufficient information has been accumulated for their decision-making.

(2) Local and remote speech recognition services in parallel/overlapping recognition

(2.1) Local speech recognition service for short utterances, both local and remote speech recognition services for longer utterances.

To optimize recognition accuracy and reduce the response time for short utterances, only a local speech recognition service can be used. This also reduces the usage of the remote speech recognition service and related usage fees.

The speech recognition service controller sets a maximum utterance duration which will limit the utterance processing to the local speech recognition service only. If the end of utterance is detected by the local speech recognition service before the maximum duration is exceeded, the local speech recognition service completes recognition of the utterance and the remote speech recognition service is not invoked. Otherwise, the speech audio will be streamed to the remote speech recognition service (starting with the audio buffered from the sufficiently padded start of speech).

Depending on the recognition confidence level for partial results streamed by the local speech recognition service, the speech recognition service controller can decide to start using the remote speech recognition service. If the utterance is rejected by the local speech recognition service, the speech recognition service controller will start using the remote speech recognition service.

The speech recognition service controller sends “start listening” to the local speech recognition service. The local speech recognition service detects the start of speech utterance, notifies the speech recognition service controller of this event and initiates streaming of speech recognition results to the speech recognition service controller which directs them to the response concept service system. When the local speech recognition service detects the subsequent end of utterance, it notifies the speech recognition service controller of this event. The local speech recognition service returns the final recognition hypotheses with their scores to the speech recognition service controller.

Upon receipt of the “start of speech utterance” notification from the local speech recognition service, the speech recognition service controller sets the pre-defined maximum utterance duration. If the end of utterance is detected before the maximum duration is exceeded, the local speech recognition service completes recognition of the utterance. The remote speech recognition service is not invoked.

If the utterance duration exceeds the specified maximum while the local speech recognition service continues recognizing the utterance and streaming partial results, the speech recognition service controller sends “start listening” and starts streaming the utterance audio data (including a buffered audio from the start of the utterance) to, and receiving streamed recognition results from, the remote speech recognition service. The streams of partial recognition results from the local and remote speech recognition services are merged by the speech recognition service controller and used as input into the response concept service system. The end of recognition notification is sent to the speech recognition service controller by the two speech recognition service engines when these events occur.

However, if the confidence score of the partial recognition results by the local speech recognition service are considered low according to some criterion (e.g., below a set threshold), the speech recognition service controller will start using the remote speech recognition service if it has not done that already.

If the utterance is rejected by the local speech recognition service, the speech recognition service controller will start using the remote speech recognition service (if it has not done that already). A video segment of a “speed equalizer” is played while streaming the audio to a remote speech recognition service and processing the recognition results.

(3) Auxiliary expert—a local speech recognition service is specialized on recognizing speech characteristics such as prosody, stress, rate of speech, etc.

This recognizer runs alongside other local recognizers and shares the audio input channel with them.

(4) A Fail-over backup to tolerate resource constraints (e.g. no network resources)

If the loss/degradation of the network connectivity is detected, the speech recognition service controller is notified of this event and stops communicating with the remote speech recognition service (i.e. sending start/stop listening commands and receiving streamed partial results). The speech recognition service controller resumes communicating with the remote speech recognition service when it is notified that network connectivity has been restored.

### Social Media Sharing

This section describes audio/video recording and transcription of the user side of a conversation as means of capturing user-generated content. It also presents innovative ways of sharing the recorded content data as the whole or in parts on social media channels.

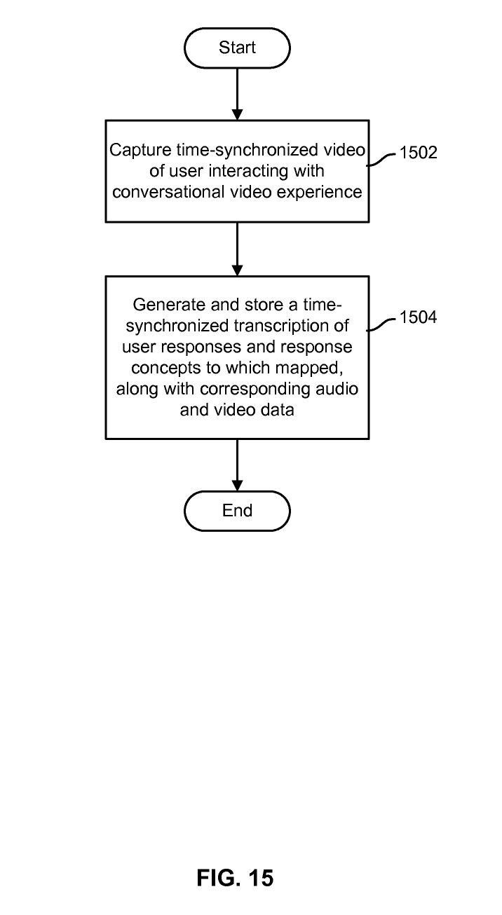

FIG. 15 is a flow chart illustrating an embodiment of a process to record a user's side of a conversational video experience. In the example shown, a time-synchronized video recording is made of the user while the user is interacting with the conversational video experience (1502). For example, during a conversation between a virtual persona and a real user, the conversational video runtime system in various embodiments performs video capture of the user while they listen to, and respond to, the persona's video prompts. The audio/video capture may utilize a microphone and a front-facing camera of the host device. The captured audio/video data is recorded to a local storage as a set of video files. The capture and recording are performed concurrently with the video playback of the persona's prompts (both speaking and active listening segments). The timing of the video capture is synchronized with that of the playback of the video prompts, so that it is possible to time-align both video streams.

Furthermore, transcriptions of the user's actual responses and the corresponding response concepts are logged and stored (1504). The user's responses are automatically transcribed into text and interpreted/summarized as response concepts by the input recognition and response concept services, respectively. The automatically transcribed and logged responses may be hand-corrected/edited by the user.

Audio/video recordings and transcriptions of the user's responses can be used for multiple types of social media interactions:

A user's video data segments captured during a persona's speaking and active listening modes can be sequenced with the persona-speaking and active listening segments to reconstruct an interactive exchange between both sides of the conversation. These segments can be sequenced in multiple ways including alternating video playback between segments or showing multiple segments adjacent to each other. These recorded video conversations can be posted in part or in their entirety to a social network on behalf of the user. These published video segments are available for standalone viewing, but can also serve as a means of discovery of the availability of a conversational video interaction with the virtual persona.

Selected user recorded video segments on their own or sequenced with recorded video segments of other users engaging in a conversation with the same virtual persona can be posted to social networks on behalf of the virtual (or corresponding real) persona.

The transcribed actual or response concepts from multiple users engaging in a conversation with the same virtual persona can be measured for similarity. Data elements or features collected for multiple users by the personal profiling service can also be measured for similarity. Users with a similarity score above a defined threshold can be connected over social networks. For example, fans/admirers/followers of a celebrity can be introduced to each other by the celebrity persona and view their collections of video segments of their conversations with that celebrity.

### Integrating Human Agents

There may be occasions for some applications to involve a human agent. This human agent—a real person connected via a video and/or audio channel to the user—could be an additional participant in the conversation or a substitute for the virtual persona. The new participant could be selected from a pool of available human agents or could even be the real person on whom the virtual persona is based. The decision to include a human agent may only be taken if there is a human agent available, determined by integration with a present system.

Examples of scenarios in which human agents would be integrated may include cases where the conversation path goes outside the immediate conversation domain. In such a case, the virtual persona could indicate he/she needs to ask their assistant. They would then “call out” on a speakerphone, and a real agent's voice could say hello. The virtual persona would then say, “Please tell my assistant what you want” or the equivalent. At that point, the user would interact with the agent by simulated speakerphone, with the virtual persona nodding occasionally or showing other appropriate behavior. At the end of the agent interaction, a signal would indicate to the app on the mobile device or computer that the virtual persona should begin interacting with the user. This use allows conventional agents serving, for example, call centers, to treat the interaction as a phone call, but for the user to continue to feel engaged with the video.

The integration could also be subtler, with “hidden” agents. That is, when the system can't decipher what the user is saying, perhaps after a few tries, an agent could be tapped in to listen and type a response. In some cases, the agent could simply choose a pre-written response to the question. A text-to-speech system customized to the virtual persona's voice could then speak the typed response. The video system could be designed to simulate arbitrary speech; however, it may be easier to just have the virtual persona pretend to look up the answer on a document, hiding the virtual persona's lips, or a similar device for hiding the virtual persona's mouth. The advantage of a hidden agent in part is that agents with analytic skills that might have accents or other disadvantages when communicating by speech could be used.

For a certain pattern of responses, the conversation could transfer to a real person, either a new participant or even the real person on whom the virtual participant is based. For example, in a dating scenario the conversational video could ask a series of screening questions and for a specific pattern of responses, the real person represented by the virtual persona could be brought in if he/she is available. In another scenario, a user may be given the opportunity to “win” a chance to speak to the real celebrity represented by the virtual persona based on a random drawing or other triggering criteria.

### Integrating Audio-Only Content

Having video coverage for new developments or content seldom used may not be cost-effective or even feasible. This can be addressed in part by using audio-only content within the video solution. As with human agents, the virtual persona could “phone” an assistant, listen to a radio, or ask someone “off-camera” and hear audio-only information, either pre-recorded or delivered by text-to-speech synthesis. In that latter case, the new content could originate as text, e.g., text from a news site, for example. Audio-only content could also be environmental or musical, for example if the virtual persona played examples of music for the user for possible purchase.

Using techniques disclosed herein, a more natural, satisfying conversational video experience may be provided.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of providing a conversational video experience, comprising:
receiving a user response data provided by a user in response to a first video segment at least a portion of which has been rendered to the user;
processing the user response data to generate a text-based representation of a user response indicated by the user response data;
determining based at least in part on the text-based representation a response concept with which the user response is associated; and
selecting based at least in part on the response concept a next video segment to be rendered to the user.

2. The method of claim 1, wherein the user response data comprises audio data associated with user speech.

3. The method of claim 2, wherein processing the user response data to generate a text-based representation of a user response indicated by the user response data includes performing is speech recognition processing.

4. The method of claim 3, wherein the text-based representation of the user response indicated by the user response data includes an n-best or other set of hypotheses generated by said speech recognition processing.

5. The method of claim 1, wherein said response concept is determined at least in part by comparing said text-based representation to one or more entities comprising a response understanding model.

6. The method of claim 5, further comprising updating said understanding model based at least in part on said text-based representation of the user response.

7. The method of claim 1, wherein said response concept is included in a predetermined set of response concepts each of which is defined within a domain with which the conversational video experience is associated.

8. The method of claim 1, wherein said first video segment includes a prompt portion, in which a video persona prompts the user to provide a response.

9. The method of claim 8, wherein said first video segment includes an active listening portion, in which a video persona engages in one or both of verbal and non-verbal behaviors associated with listening attentively to another.

10. The method of claim 9, wherein a transition from playing the prompt portion to playing the active listening portion occurs dynamically, upon detecting that the user has begun to speak.

11. The method of claim 10, further comprising processing a partial response by the user to determine provisionally an associated response concept, and transitioning from the active listening portion of the first video segment to a second active listening video that is more specific to the provisionally determined response concept than the active listening portion of the first video segment.

12. The method of claim 11, further comprising generating dynamically and inserting dynamically in a video stream to be played back a transition between the active listening portion of the first video segment and the second active listening video.

13. The method of claim 1, wherein the response concept is determined based at least in part is on a context data, including one or more of a conversation context, a conversation history, and a user profile.

14. The method of claim 1, wherein the user response may be provided via two or more input modalities.

15. The method of claim 1, further comprising displaying a set of user selectable response options available to be selected by the user to generate the user response data indicating the user's response.

16. The method of claim 15, wherein the set of user selectable response options is displayed in response to one or both of the user selecting a control associated with display of said user selectable response options and expiration of a prescribed time period without user speech input having been received since a prompt portion of the first video segment has finished playing.

17. The method of claim 1, further comprising integrating a live human agent into the conversational video experience.

18. The method of claim 1, further comprising integrating audio-only content into the conversational video experience.

19. A system to provide a conversational video experience, comprising:
a processor configured to:
receive a user response data provided by a user in response to a first video segment at least a portion of which has been rendered to the user;
process the user response data to generate a text-based representation of a user response indicated by the user response data;
determine based at least in part on the text-based representation a response concept with which the user response is associated; and
select based at least in part on the response concept a next video segment to be rendered to the user; and
a memory configured to provide the processor with instructions.

20. The system of claim 19, further comprising a communication interface coupled to the processor and wherein the processor is configured to process the user response data to generate the text-based representation of the user response indicated by the user response data at least in is part by sending via the communication interface a request to an external, network-based input recognition service.

21. The system of claim 19, further comprising a display device coupled to the processor and wherein the first video segment and the next video segment are rendered to the user via the display device.

22. The system of claim 19, further comprising a user input device and wherein the user response data provided by the user in response to the first video segment is associated with input received via the user input device.

23. The system of claim 22, wherein the user input device comprises a microphone and the user input data comprises audio data representing an audible response uttered by the user.

24. The system of claim 22, wherein the user input device comprises a user-facing camera and the user input data comprises video data representing video images of the user responding to the first video segment.

25. A computer program product embodied in a non-transitory computer readable storage medium and comprising computer instructions for:
receiving a user response data provided by a user in response to a first video segment at least a portion of which has been rendered to the user;
processing the user response data to generate a text-based representation of a user response indicated by the user response data;
determining based at least in part on the text-based representation a response concept with which the user response is associated; and
selecting based at least in part on the response concept a next video segment to be rendered to the user.
